(19) United States
(12) Patent Application Publication
(10) Pub. No.: US 2022/0309553 A1
(43) Pub. Date: Sep. 29, 2022

(54) SYSTEMS AND METHODS FOR COLLABORATIVE SHOPPING

(71) Applicant: AT&T Intellectual Property I, L.P., Atlanta, GA (US)

(72) Inventors: David Crawford Gibbon, Lincroft, NJ (US); Eric Zavesky, Austin, TX (US); Tan Xu, Bridgewater, NJ (US); Ganesh Subramaniam, Bridgewater, NJ (US); Louis Alexander, Franklin, NJ (US); Paul Triantafyllou, Summit, NJ (US); Mohammed Abdel-Wahab, Madison, NJ (US)

(73) Assignee: AT&T Intellectual Property I, L.P., Atlanta, GA (US)

(21) Appl. No.: 17/212,764

(22) Filed: Mar. 25, 2021

(51) Int. Cl. G06Q 30/06; G06Q 50/00; G06F 16/2457

(52) U.S. Cl. CPC G06Q 30/0619; G06Q 30/0643; G06Q 30/0639; G06Q 50/01; G06F 16/24578; G06Q 10/087

(57) ABSTRACT

Aspects of the subject disclosure may include, for example, facilitating a collaborative shopping session between first equipment of a first user and second equipment of a second user; obtaining a first shopping preference of the first user; obtaining a first image of first stock currently available for purchase in a first physical store; selecting, based at least in part upon the first shopping preference of the first user, a selected other physical store, the selected other physical store being selected from among at least a second physical store and a third physical store; obtaining a second image of second stock currently available for purchase in the selected other physical store; combining the first image and the second image into a combined image; sending to the first equipment the combined image; and sending to the second equipment the combined image. Other embodiments are disclosed.

### FIELD OF THE DISCLOSURE

The subject disclosure relates to systems and methods for collaborative shopping.

### BACKGROUND

Various mechanisms for collaborative shopping (e.g., online collaborative shopping) exist. The collaboration can often be between friends and/or family members.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communications network in accordance with various aspects described herein.

FIG. 2A is a block diagram illustrating an example, non-limiting embodiment of a system functioning within the communications network of FIG. 1 in accordance with various aspects described herein.

FIG. 2B is a block diagram illustrating an example, non-limiting embodiment of a system functioning within the communications network of FIG. 1 in accordance with various aspects described herein.

FIG. 2C is a block diagram illustrating an example, non-limiting embodiment of a display provided by certain user equipment of FIG. 2B.

FIG. 2D is a block diagram illustrating an example, non-limiting embodiment of a display provided by certain user equipment of FIG. 2B.

FIG. 2E depicts an illustrative embodiment of a method in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for collaborative shopping. Other embodiments are described in the subject disclosure.

One or more aspects of the subject disclosure can include a mechanism to facilitate collaborative shopping between a first user who is physically located in a first physical store and a second user who is not physically located in the first physical store. In one example, the first user can utilize a mobile communication device that provides to the first user an augmented reality (AR) view of a portion of an interior of the first physical store along with a picture-in-a-picture type view showing a portion of an interior of a second (different) physical store. Further, in this example, the second user can utilize a communication device (either mobile or fixed) that provides to the second user the same view as seen by the first user (in this example, the view of the portion of the interior of the first physical store along with the picture-in-a-picture type view showing the portion of the interior of the second (different) physical store). Further still, in this example, the view of the portion of the interior of the first physical store can show an item that is for sale and the picture-in-picture type view can show another (possibly identical or similar) item that is for sale in the second (different) physical store.

One or more aspects of the subject disclosure can include a mechanism to facilitate collaborative shopping between a first user who is not physically located in a first physical store and a second user who is also not physically located in the first physical store. In one example, the first user can utilize a first communication device (either mobile or fixed) that provides to the first user a view of a portion of an interior of the first physical store along with a picture-in-a-picture type view showing a portion of an interior of a second (different) physical store. Further, in this example, the second user can utilize a second communication device (either mobile or fixed) that provides to the second user the same view as seen by the first user (in this example, the view of the portion of the interior of the first physical store along with the picture-in-a-picture type view showing the portion of the interior of the second (different) physical store). Further still, in this example, the view of the portion of the interior of the first physical store can show an item that is for sale and the picture-in-picture type view can show another (possibly identical or similar) item that is for sale in the second (different) physical store.

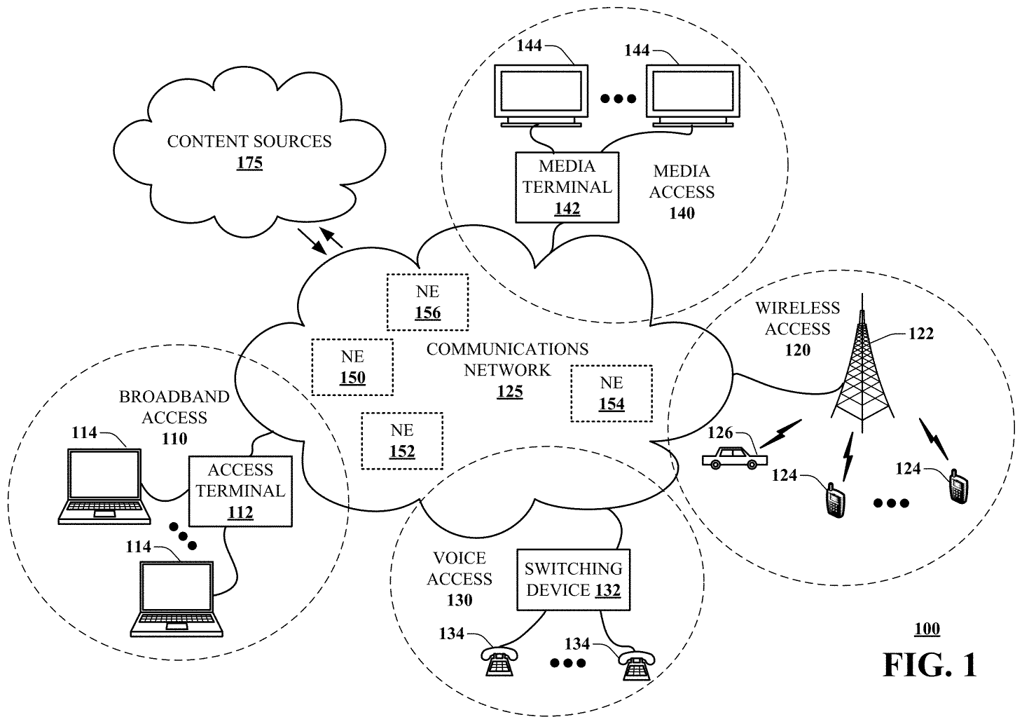

Referring now to FIG. 1, a block diagram is shown illustrating an example, non-limiting embodiment of a system 100 in accordance with various aspects described herein. For example, system 100 can facilitate in whole or in part collaborative shopping (e.g., collaborative shopping between a first user in a first location and a second user in a second (different) location). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

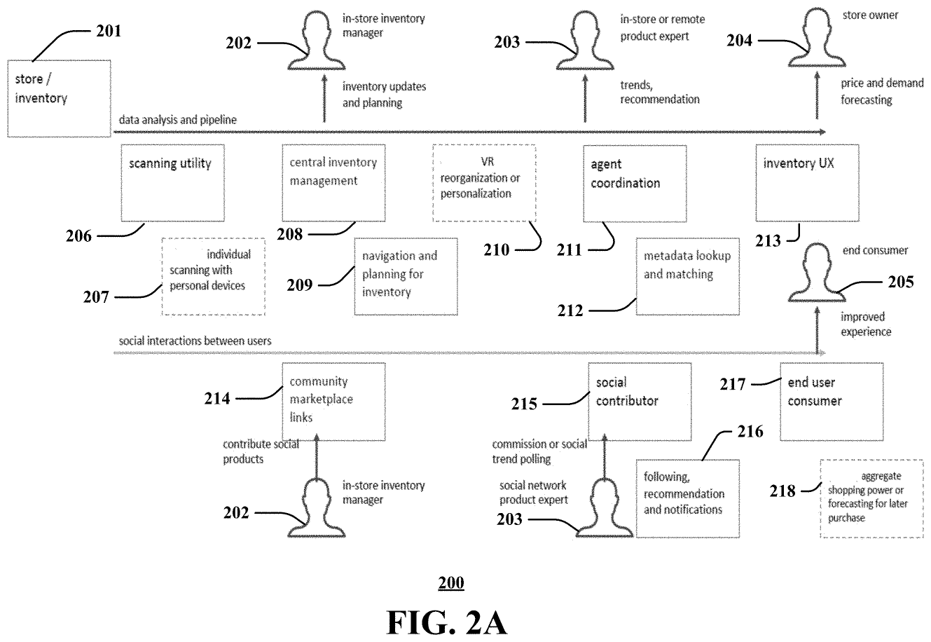

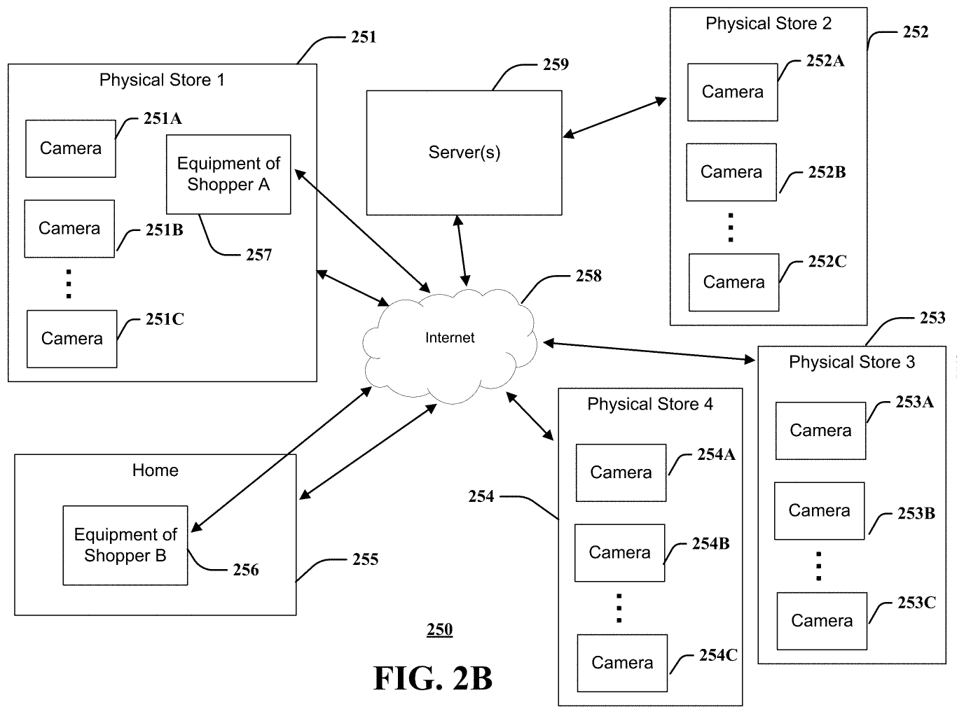

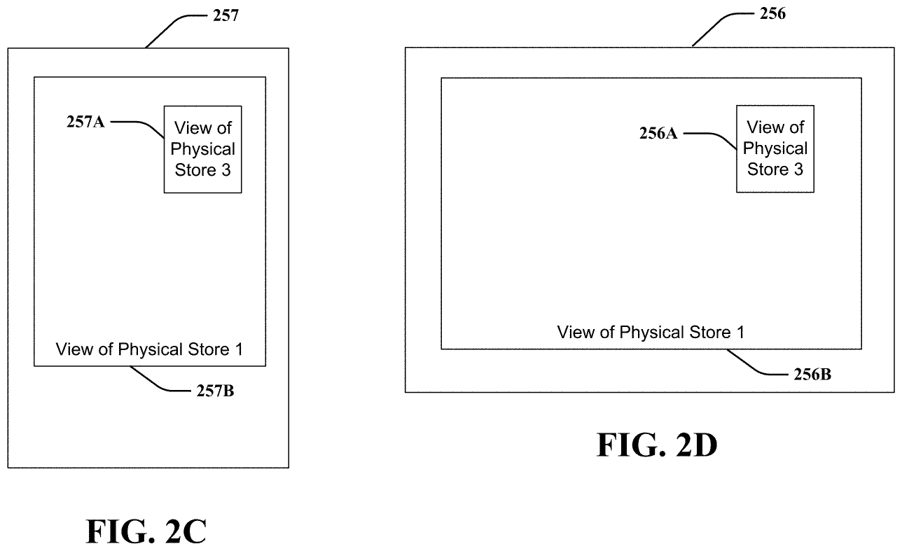

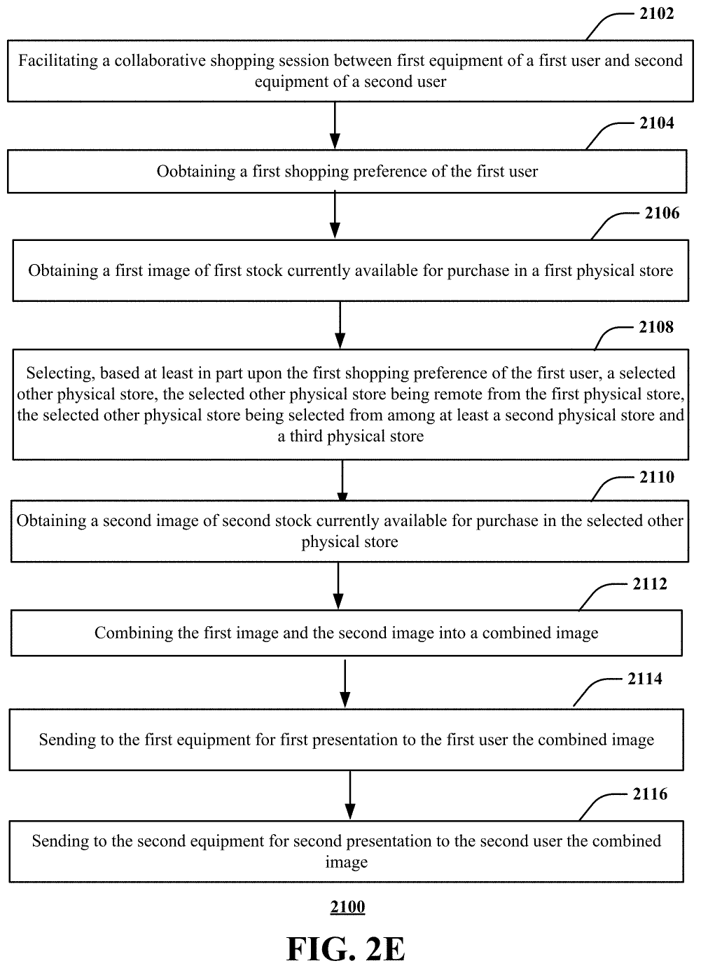

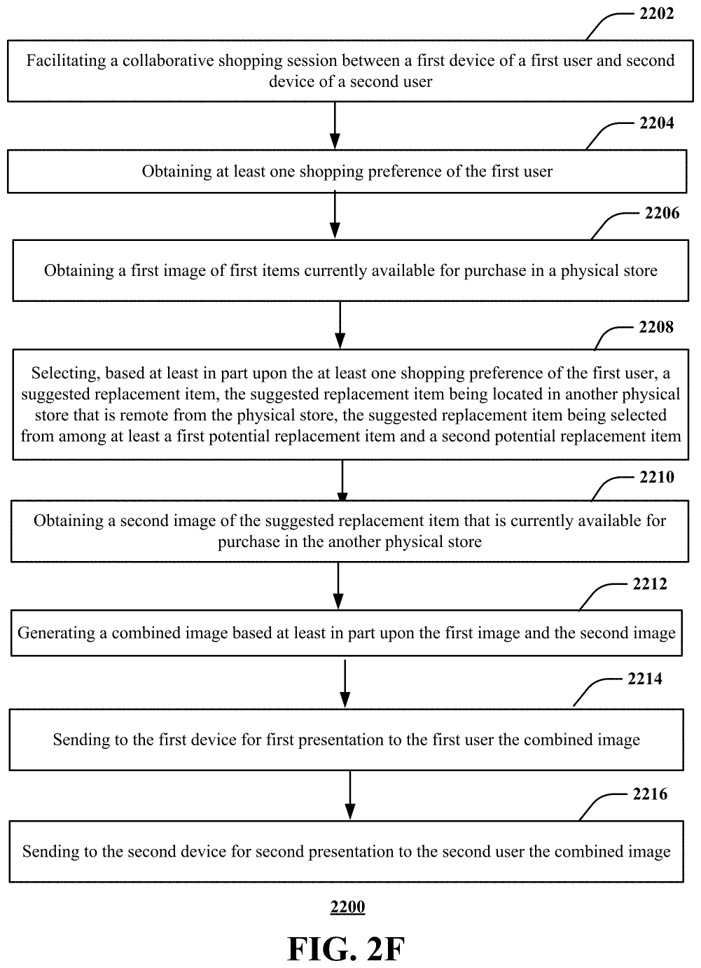

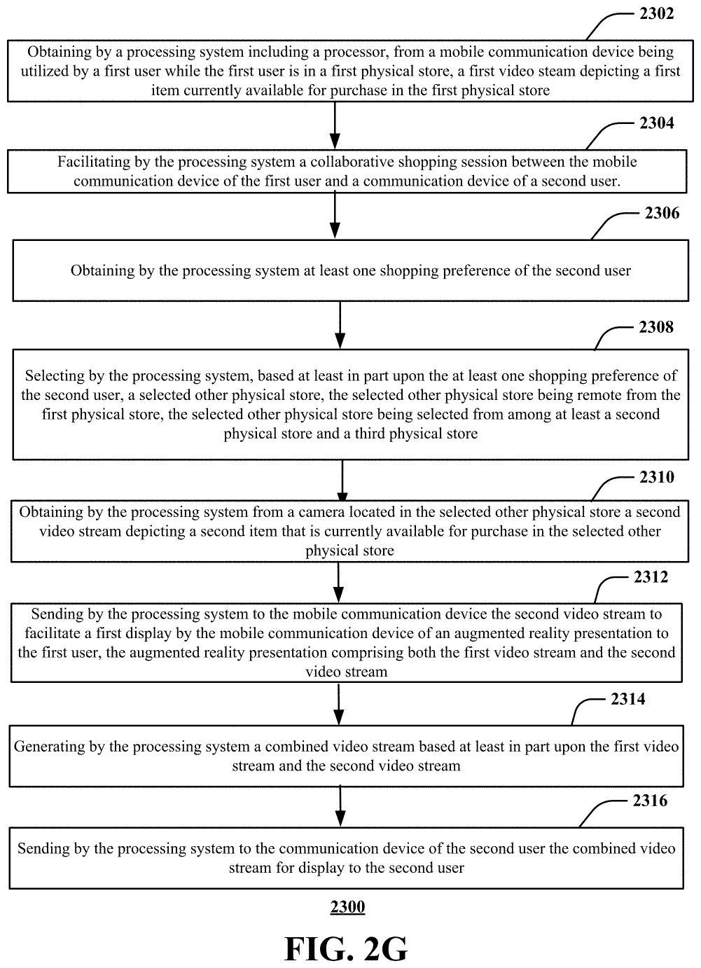

FIG. 2A is a block diagram illustrating an example, non-limiting embodiment of a system 200 functioning within the communications network of FIG. 1 in accordance with various aspects described herein. More particularly, system 200 includes a data analysis and pipeline (shown as the upper horizontal arrow in this figure). The data analysis and pipeline provides data regarding store/inventory (see store/inventory 201) to in-store inventory manager 202 (see the inventory updates and planning arrow), to in-store or remote product expert 203 (see the trends, recommendation arrow), and to store owner 204 (see the price and demand forecasting arrow). In addition, the data analysis and pipeline provides data to and/or receives data from scanning utility 206, individual scanning with personal devices 207, central inventory management 208, navigation and planning for inventory 209, VR (virtual reality) reorganization or personalization 210, agent coordination 211, metadata lookup and matching 212, and inventory UX (user experience) 213.

Still referring to FIG. 2A, it is seen that various social interactions are facilitated between (and/or among) users (see the lower horizontal arrow in this figure).

The social interactions can include the in-store inventory manager 202 contributing social products in the context of community marketplace links 214, social network product expert 203 contributing commissions or social trend polling (along with following, recommendation and notifications—see 216) via social collaborator 215, and end user consumer 205/217 (who can, along with other such users, aggregate shopping power or forecasting for later purchase—see 218).

Referring now to FIG. 2B, this is a block diagram illustrating an example, non-limiting embodiment of a system 250 functioning within the communications network of FIG. 1 in accordance with various aspects described herein. More particularly, system 250 operates in the context of physical store 251 (which includes cameras 251A, 251B, 251C), physical store 252 (which includes cameras 252A, 252B, 252C), physical store 253 (which includes cameras 253A, 253B, 253C), and physical store 254 (which includes cameras 254A, 254B, 254C). Each of physical stores 251, 252, 253 and 254 is located remotely from the other. Each of the cameras in the various physical stores is configured for bi-directional communication with server(s) 259 via Internet 258 in order to facilitate various collaborative shopping functionality described herein. While four physical stores are shown, any number of physical stores can be utilized. Further, while three cameras are shown in each physical store, any number of camera(s) can be utilized (and each physical store can have a different number of cameras or a same number of cameras). In one example, each of the physical stores can be operated by a different entity. In another example, one or more of the physical stores can be operated by a same entity. In another example, all of the physical stores can be operated by a same entity. In another example, each camera can be operated by a store and/or by individual users. In one specific example, a shopper can capture images/data of what is on a shelf which may (or which may not) be in combination with one or more store-operated cameras doing the same thing. In another example, there can be a combination of different information gathering (e.g., one or more user devices collecting information about availability (e.g., images, etc.) and one or more pieces of store equipment providing other information (e.g., prices, etc.)).

Still referring to FIG. 2B, in this example, the equipment of shopper A 257 is located within physical store 251. The equipment of shopper A 257 can be mobile communication equipment and can comprise, for example, a smartphone, a tablet computer or the like. Further, in this example, the equipment of shopper B 256 is located in the home of shopper B. The equipment of shopper B 256 can comprise a desktop, computer, a laptop computer, a tablet, or the like. In another example, both shoppers A and B can utilize mobile communication equipment. In another example, both shoppers A and B can utilize fixed communication equipment. In another example, both shoppers A and B can be located remotely from physical store 1 251 (e.g., each of shopper A and B can be located at a respective home, at a respective work location, or at any other location). The equipment of shopper A 257 is configured for bi-directional communication with servers(s) 259 via Internet 258 in order to facilitate various collaborative shopping functionality described herein. The equipment of shopper B 256 is configured for bi-directional communication with servers(s) 259 via Internet 258 in order to facilitate various collaborative shopping functionality described herein.

Referring now to FIG. 2C, this is a block diagram illustrating an example, non-limiting embodiment of a display provided by certain user equipment of FIG. 2B. More particularly, this FIG. 2C shows (for equipment of shopper A 257) a view of physical store 1 257B that has an inset (or picture-in-picture) view of physical store 3 257A. In this example, the equipment of shopper A 257 is in a form of a smartphone, a tablet computer or the like. Further, in this example, the view of physical store 1 257B is configured to show various items on shelves in an aisle in physical store 1 251. Further, in this example, the view of physical store 3 257A is configured to show various items on shelves in an aisle in physical store 3 253. In other examples, the inset view can be of the interior of one of the other physical stores.

Referring now to FIG. 2D, this is a block diagram illustrating an example, non-limiting embodiment of a display provided by certain user equipment of FIG. 2B. More particularly, this FIG. 2D shows (for equipment of shopper B 256) a view of physical store 1 256B that has an inset (or picture-in-picture) view of physical store 3 256A. In this example, the equipment of shopper B 256 is in a form of a desktop computer, a laptop computer or the like. Further, in this example, the view of physical store 1 256B is configured to show various items on shelves in an aisle in physical store 1 251. Further, in this example, the view of physical store 3 256A is configured to show various items on shelves in an aisle in physical store 3 253. In other examples, the inset view can be of the interior of one of the other physical stores.

In various embodiments, a system (e.g., the system shown in FIG. 2A or the system shown in FIG. 2B) can operate and/or provide functionality as follows. More particularly, the functionality can include real-time inventory scanning from visual understanding. In various examples, this can include: (a) object recognition, context analysis, etc.—help to recognize which objects (e.g., food, furniture, etc.) are in an area; (b) higher precision analysis that can determine attributes (e.g., size, shape, ripeness); (c) real-time update(s) that can occur with each persons' interaction to keep inventory record; (d) a display that can be updated and inventory that can be in back of store wherein only certain items are distributed; and/or (e) scanning of objects that can be accomplished by individuals (e.g., robot, human) instead of (or in addition to) ambient computer vision.

Further, the above-mentioned functionality can include inventory management of products locally and augmented by cloud service. In various examples, this can include: (a) for in-store activity, navigation executed locally, but shopping item managed by cloud; (b) for virtual activity, visualize shelves for VR experience user's environment (e.g., place bread +milk +toys adjacent in virtual space); and/or (c) linkage from community—can add products from own stores via recognition and inventory linking.

Further still, the above-mentioned functionality can include agent coordination and personalized recommendations (e.g., multi-shopper and expert collaboration). In various examples, this can include: (a) enable agents (human and/or automatic) to provide trends to shoppers and link to external data (e.g., recipes, product specs, etc.); (b) enable local and/or remote humans to respond to “more details” requests via AR and/or personal requests; and/or (c) include social recommendations and trend discovery for external experts to add to shopping experience for an item (e.g., usage examples, unboxing, following exact purchase activity).

Further still, the above-mentioned functionality can include a shopping dashboard and UX update for shopper and seller. In various examples, this can include: (a) for shopper, understand price/opportunity of different location, and enhanced product information allowing shopper to intelligently weigh costs vs. purchase location; and/or (b) for seller, understand and predict demand for items to assist in in-store promotions and pricing.

As described herein, various embodiments provide for a live visual catalog and inventory scanning—using ambient cameras and computer vision technologies to catalog the exact instance of an object in a store for both 3D placement in virtual environments and real-time inventory tracking. Various examples can use object recognition and fast model comparison to allow a secondary marketplace (e.g., third-party garage sale) to add their item and associate with store equivalent.

As described herein, various embodiments provide for a novel visualization space supporting multiple views—navigation and enablement (for in-person shopping), virtual environment (for both online and remote viewing) where others can find/browse live inventory and suggest, and virtual/personalized rendering (prioritize and place only the shopping items the user cares about).

As described herein, various embodiments provide one or more mechanisms to organically discover expert/influencers: shoppers can defer to an expert in the area for live conversation (AR or otherwise); brand and product influencers (followed or crowd-sourced) because of their interactions with user's current product; query by product/action instead of explicit search by user. Various examples can provide for inclusion of user-generated “unboxing” and experience videos for other usage examples (provide system with terms (e.g., ‘using this in a garden’) to specify what type of videos).

As described herein, various embodiments provide for inclusion of social aggregation of recommendation/actions with behaviors—aggregating by co-filtering purchased items by locality (e.g., neighbors), trends (e.g., purchase activity), family, etc.; system can reduce fraudulent reviews by confirming actual purchase; de-reference multiple expert reviews across products (e.g., via NLP) to differentiate if one brand has a specific benefit.

As described herein, various embodiments provide for collaborative distribution and merging of remote inventory—feeding a virtual store, the system can re-cast inventory from many different stores in either virtual- or augmented-reality environments. Similarly, a division of tasks among your social experts and/or matched to local market if the collaborative shopping action is distributed among multiple participants.

As described herein, various embodiments provide for interactively previewing items; receiving on-demand expert product reviews, experience testimonials; and asking for help from remote participants.

As described herein, various embodiments provide a “twinned” shopping environment to embrace interactive (AR (augmented reality)/VR (virtual reality)) and collaborative shopping experiences.

As described herein, various embodiments provide for a live visual catalog and inventory scanning—view the latest object, with high quality visuals for automated and/or human inspection remotely; personalized store overlay; correlation via object classes across marketplaces; in virtual space, rendering of live objects according to user needs and/or preferences.

As described herein, various embodiments provide for social engagement with experts and trusted connections—consult with an expert, follow prior social actions by category and/or social circle; catalog of experience and recommendations, with optional deference to experts (may include avatar guidance while you shop personally).

As described herein, various embodiments provide for collaborative distribution—feeding a virtual store, the system can re-cast inventory from many different stores in either virtual- or augmented-reality environments; division of tasks among your social experts and/or matched to local market.

Reference will now be made to use cases of virtual shopping according to various embodiments. One use case of virtual shopping is directed to an overlay with live inventory for remote viewing and assistance (e.g., shopping with a friend is easier collaboration if you have a live update). Various examples can provide a central representation that can have live version (with people there) but could also have a less rich model that has general inventory (e.g., street view visualization of the last items).

Another use case of virtual shopping is directed to an overlay method that enables refresh of exact inventory. Various examples can show specific item quality (e.g., ripeness, etc.) and quantity (e.g., number of shirts on shelf) which should capture variability for different inventory. Various examples can provide a preference learning for specification of item—whether it's a human picker or automated.

Another use case of virtual shopping is directed to a live system for demand tracking. Various examples can provide inventory tracking and volume updates—observe availability and/or demand both for consumer and supplier.

Another use case of virtual shopping is directed to navigation and identification of specific item (e.g., enablement+engagement). Various examples can provide (e.g., for those that are unfamiliar with shopping or outlay of store) help to navigate and provide best product; as a way to give personal assistants (live/remote) as needed for each shopper. Various examples can provide for discovery of related objects as you are navigating (e.g., from trending options, social recommendations).

Another use case of virtual shopping is directed to a personalized version of shopping stores (e.g., using VR re-organization). Various examples can provide inventory scanning of an in-person store (enabling rearrangement of items in a virtual space). Various examples can provide a virtual space that can be shuffled/reorganized by preferences, time of day, active need, etc.

Reference will now be made to use cases of remote control shopping according to various embodiments. One use case of remote control shopping is directed to one or more remote shoppers using AR/VR to shop and select an item. Various examples can defer to a remote viewer to determine which items are appropriate. Various examples scan and provide live video from a local person that is fed to a remote person. Various examples can provide an advantage over fully remote by providing in-person override and/or direct control.

Another use case of remote control shopping is providing an agent space (e.g., tactile/feedback). Various examples can actualize this through automated agent to pick-up and evaluate; if need other tactile feedback can use other sensors. Various examples can provide an over-the-shoulder intelligent agent (or person) who can pull up other advice and/or rating for objects. Various examples can provide agent scaling for current demand from remote people—e.g., play an ad while agent is waiting. Various examples can enable “hired personal shoppers”—pooling from either social or expert recommendations (e.g., can be recommended by local store owner for personal touch).

As described herein, various embodiments provide for in-person evaluation of clothing and furniture, solicit visual opinion from others.

As described herein, various embodiments provide for scanning and projecting a local item into remote room. In various examples, you don't need to scan your home/room at first, can catch view/object from local person and send to remote.

As described herein, various embodiments provide for collaborations across locations between different individuals. Various examples provide for sharing a unique experience or item for others to revisit (e.g., favorite salad dressing not available elsewhere, can pass the word to find this item for personal or recommendation)—is this a new endorsement. Various examples can provide for linkage by experience—use this as a query or content entry to local media host, “be a local” app for those visiting an area.

As described herein, various embodiments provide, as a benefit to a seller, more efficient management of inventory and trends among shoppers.

As described herein, various embodiments provide, as a benefit to a seller, virtual live product inventory (which enables a shopper to know exactly which product is requested and to respond to rich information queries).

As described herein, various embodiments provide, as a benefit to a shopper, time-saving and full shopping experience (e.g., recommendations, perfect inventory presentation, detail for specific items (e.g., ripeness)) even if confined to remote shopping (e.g., from home, via a secondary automated agent, etc.). Various examples can provide real-time observations about objects via live updates over computer vision and 5G. Various examples can provide VR/AR representation for new environments that cache experiences for others to use.

As described herein, various embodiments provide, as a benefit to a shopper, automatically aggregated and curated product information by product from merchant and/or social sources and includes recommendations from those prior purchase histories and/or related products.

As described herein, various embodiments provide, as a benefit to social collaboration, facilitating unification between experts (e.g., non-shoppers that are local or remote) and shoppers to assist in product choice and verification (e.g., instead of lossy video only or non-specific shopping lists).

As described herein, various embodiments provide for an inventory management system that implements integration of demand-side pricing changes—e.g., if an item (or a similar one) is not in demand, can modify the price locally, in bulk, etc., and broadcast the new price(s) as an update to those shoppers (or potential shoppers) in the area. Various examples can add other external information from smart inventory management systems (e.g., those that know weather conditions will affect product supply).

As described herein, various embodiments provide for linkage to life-cycle and/or MTBF (mean-time-between-failures) for products—social video/usage contributions continue to stream to platform to measure when/if something broke and offer additional recommendation utility.

As described herein, various embodiments provide for product recommendation and social correlation—system can predict influence of price/demand in an area with social recommendation (e.g., by recommending, a product shortage will occur).

As described herein, various embodiments provide for agent space (e.g., tactile/feedback)—can actualize this through automated agent to pick-up and evaluate; if need other tactile feedback can use other sensors; over-the-shoulder intelligent agent (or person) that can pull up other advice or rating for objects; agent scaling for current demand from remote people. Various examples can enable live agents to scan an object, stream over 3D/5G for real-time inspection remotely.

As described herein, various embodiments provide a system to enable shopping experiences with live inventory interaction and social collaboration.

As described herein, various embodiments provide many collaborative, social, and real-time inventory aspects. These embodiments can include the formulation of private and/or public streaming channels of shopping activity. These streaming channels can be user-directed (e.g., seek advice from remote participants) and/or they can be non-interactive (e.g., streamed from local to remote users with limited ability for remote users to contribute).

As described herein, various embodiments use object recognition to enable a rich inventory system and collaboration.

As described herein, various embodiments connect products and social interactions (both local and remote) for collaboration.

As described herein, various embodiments provide an online shopping environment that allows user(s) to interactively preview items, receive on-demand expert product reviews, experience testimonials, and/or ask for help from remote participants.

As described herein, various embodiments provide a generic shopping platform unification for both shoppers and merchants, reducing costs and moving classic inventory items to a digital representation.

As described herein, various embodiments provide for extending the touch of together entertainment (e.g., to help with collaborative shopping and retail). Previously, the intersection of shopping and social experiences (or entertainment) was typically static or one-way. In contrast, various embodiments can enable instantaneous social engagement in both fully engaged (communications between all users) and passive or partial engagements (e.g., notifications, alerts, requests to focus on specific items). Additionally, novel entertainment opportunities are created by various embodiments that synchronously share progress on a shopping list (e.g., for competitive gaming) and establish connections between one or more real physical locations and virtual locations such that the user immersion is rich regardless of one's placement in the remote or local connections.

As described herein, various embodiments provide for a video streaming model where people can split up a task or “over the shoulder” review one larger task execution. Such “over the shoulder” process can include: a single task list that is coordinated to all participants; one or more video feeds from first-person and/or environment video that are aggregated; watchers/audience that give advice to the active/primary user on specific requests (like remote assistance); remote shoppers are given a richer experience based on image/video rec and external document linkage (e.g. ripeness and availability of fruit, etc.); and/or in one scenario, a “call for help” can be executed if a person (e.g., the shopper, a personal shopper acting on behalf of a shopper, an INSTACART shopper) wants to understand what item or type of ripeness is desired (this question can be synchronous or give a set of options (either live or previously seen) as an extension, the system can detect and preempt this need when remote is ordering). In other embodiments a collaborative process can: split a list among many people, each can check off the item either manually, semi-automated (e.g., take a picture), or fully automated (e.g., body-camera recognizes objects); and/or can communicate with a text, audio, and/or video blurb for each item for subsequent live or asynchronous review. In other embodiments, one or more mechanisms can provide a high personalization of content, medium interaction, and automatic generation of content.

As described herein, various embodiments provide for one or more mechanisms that: enable modifying a shopping list in real-time based on feedback; enable an in-person attendee to have AR (augmented reality) capability and remote people can highlight the item that they want or point out specific items that are within views (this can help those who are remote/incapable to feel like part of experience); enable synthesis, wherein layout/positioning can be simulated; enable multiplexing (e.g., a personal shopper acting on behalf of a shopper or INSTACART order filler); map the store and recent/continuous capture overlays the new content; enables people to point and click to specific item for either a robot or human to grab that target (this can implement, for example, haptic feedback); enable an app where you log into a shop and browse those aisles; enable place-holder boxes for creating 3D inventory and environment; enable robot-picking, which can approximate tactile/criterion with click or evaluation through virtual interface (e.g. dispatch of agents); enable others to give suggestions for different styles; enable background research and helping; enable a virtual store and understanding what's in stock in that store (e.g., you pre-shop within a store and can alert your friend that you've found something here (e.g. discover other items and suggest to you)); limit/reduce the voices from others; capture 3D model in live and share that remotely for others to view, price match, color pick, etc. (consider, e.g., the furniture shopping space); enable (e.g., if item has barcode) finding other things to do with it (e.g., recipe, potential uses, etc.)—in order to give user sufficient information; enable links to knowledge base and better information for immediate consumer; enable functionality to “phone a friend” for better consultancy on using an object (e.g., a domain expert can help there); enable asking a tester to (for example) open a door, push button, and evaluate (e.g., for car shopping); enable queue of tasks for if a product is available; enable proposal of queuing of the tasks and requests for evaluation (e.g., can be auto-categorized by NLP, vision, etc.; enable parallel shopping; enable functionality to send out multiple people to shop for same item; using, e.g., real-time optimization for correct criterion (e.g., one at store A, one to store B)—wherein one goal is optimizing quality for request; enable storing preferences (e.g., squeeze, ripeness) with the store as you exit for user personalization; enable navigation and fullness; enable shopping and prioritization—organize by proximity and crowdedness of the items; enable placement of employees based on traffic/request need; enable scheduling (e.g., incorporate other hours for what/when it can be done); and/or enable functionality wherein, for example, a person at home can navigate a person in a store by browsing different aisles in the shop using a collaborative shopping app.

As described herein, various embodiments provide for one or more mechanisms that: enable accommodation of experts; provide notification to “following” people for what you have bought or what you may have done (e.g., this user bought X with Y—combination of recommendation +social piece of why it was used); enable follow other buyers; restrict actions for certain types/categories of products (e.g., aggregate to a neighborhood for restriction); enable reviews of/with people; enable celebrities that have opted-in to share; enable collaborative/social—marketplaces run by communities (e.g., person selling individual object that is recognized from your in-person shopping experience); enable viewing by shopper of condition of the item; and/or benefit from linkage with 5G.

As described herein, various embodiments provide for a live visual catalog, social engagement; and/or collaborative distribution.

As described herein, various embodiments provide for shopping in which one or more 3D cameras generate one or more visual twins.

As described herein, various embodiments provide for real-time inventory response (e.g., using cameras in stores).

As described herein, various embodiments provide for a shopper being able to reserve an item (e.g., after one shopper reserves the final instance of an item that is in stock, the system can tell other shoppers “sorry, not available”).

As described herein, various embodiments provide for experts who can discuss one or more items that are in a store.

As described herein, various embodiments provide for personalized versions of shopping stores. Various examples can provide for stores (e.g., online stores) that are personalized for multiple collaborative shoppers (e.g., recommendations based on shoppers (e.g., all collaborating shoppers)). Various examples can provide for predicting additional items (e.g., recipes, patterns).

As described herein, various embodiments provide for ad hoc markets that use mobile cameras.

As described herein, various embodiments provide for live inventory, live inventory scan, digital representation, inventory catalog.

As described herein, various embodiments can utilize 3D scanning and/or IR (infra-red) scanning.

As described herein, one or more images of an item (or items) for sale by a third party can be included in the display to the shoppers.

As described herein, artificial intelligence and/or machine learning models of items for sale can be customized for each individual store (e.g., utilizing object recognition).

As described herein, 3D topography and/or a 3D camera can be utilized.

As described herein, a 3D camera can facilitate determining an object and determining where the object is located. In one example, the object model and the inventory can be placed in the same spot.

As described herein, an avatar can guide a user through a virtual space.

As described herein, a model can be generated based upon 3D imaging data combined with human interaction.

As described herein, object recognition can facilitate corresponding display (e.g., unboxing, technical manuals, etc.).

As described herein, local and remote people can be coordinated.

As described herein, real-time inventory response can be facilitated (e.g., correspondence between scanned inventory and reported inventory).

As described herein, a particular item can be placed on hold by a shopper (wherein a subsequent shopper can be told “that item is no longer available for sale”).

As described herein, a shopping list can be used to plan a navigation path.

As described herein, an expert can be remote and can see a video feed from a store.

As described herein, one or more other stores can send images of their respective real-time inventory (such other real-time inventory can be displayed via AR (augmented reality) and/or via VR (virtual reality).

As described herein, an expected demand can be used to facilitate just-in-time delivery.

As described herein, a virtual store can have a configuration that is laid out differently from a corresponding physical store (e.g., a virtual store layout can be presented that is personalized to a particular shopper).

As described herein, a virtual store can have a configuration that is modified in real-time for a given shopper based upon item(s) that the shopper has added to a cart and/or has viewed (e.g., such as showing certain spices based upon meat that is placed in a cart).

As described herein, a virtual store can have a configuration that is modified in real-time for a given shopper based upon item(s) that a collaborating shopper has added to a cart and/or has viewed.

As described herein, a virtual store can have a configuration that is modified in real-time for a given shopper based upon one or more recommendations (e.g., recommendation(s) of a collaborating shopper and/or recommendation(s) of a third-party expert).

As described herein, various embodiments can be applied in the context of a farmer's market or the like (e.g., in the context of a shopper using a mobile phone to acquire images at an ad hoc shopping location).

As described herein, various embodiments can facilitate demand side pricing.

As described herein, various embodiments can provide AR (augmented reality) and/or VR (virtual reality) displays that link to secondary information, that provide display of a particular product, that highlight a particular product for purchase, that provide a heat map, that provide a warning indicator (e.g., highlighting) not to purchase a particular product (e.g., with respect to a recalled product), and/or that provide a paint-out of view of a particular product (e.g., with respect to a recalled product).

As described herein, agents can provide to a virtual shopper tactile feedback (e.g., glove with force feedback).

Referring now to FIG. 2E, various steps of a method 2100 according to an embodiment are shown. As seen in this FIG. 2E, step 2102 comprises facilitating a collaborative shopping session between first equipment of a first user and second equipment of a second user. Next, step 2104 comprises obtaining a first shopping preference of the first user. Next, step 2106 comprises obtaining a first image of first stock currently available for purchase in a first physical store. Next, step 2108 comprises selecting, based at least in part upon the first shopping preference of the first user, a selected other physical store, the selected other physical store being remote from the first physical store, the selected other physical store being selected from among at least a second physical store and a third physical store. Next, step 2110 comprises obtaining a second image of second stock currently available for purchase in the selected other physical store. Next, step 2112 comprises combining the first image and the second image into a combined image. Next, step 2114 comprises sending to the first equipment for first presentation to the first user the combined image. Next, step 2116 comprises sending to the second equipment for second presentation to the second user the combined image.

In one example, a mechanism can provide for placing representations of the first item into an order and virtual placement according to second user preferences (e.g., first user or store sees items and second user sees virtual store that is configured for their preferences).

In one example, the facilitating the collaborative shopping session can comprise facilitating communication between the first equipment of the first user and the second equipment of the second user. In various examples, the communication can comprise visual communication, audio communication, or any combination thereof. In one example, the first user and the second user can be part of a same family. In one example, the first user and the second user can be part of a same social organization. In one example, the same social organization can be electronically created as “followers”. In one example, the same social organization can be created via explicit household and/or family relationship. In one example, the same social organization can be a social organization derived by a social network connection.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2200 according to an embodiment are shown. As seen in this FIG. 2F, step 2202 comprises facilitating a collaborative shopping session between a first device of a first user and second device of a second user. Next, step 2204 comprises obtaining at least one shopping preference of the first user. Next, step 2206 comprises obtaining a first image of first items currently available for purchase in a physical store. Next, step 2208 comprises selecting, based at least in part upon the at least one shopping preference of the first user, a suggested replacement item, the suggested replacement item being located in another physical store that is remote from the physical store, the suggested replacement item being selected from among at least a first potential replacement item and a second potential replacement item. Next, step 2210 comprises obtaining a second image of the suggested replacement item that is currently available for purchase in the another physical store. Next, step 2212 comprises generating a combined image based at least in part upon the first image and the second image. Next, step 2214 comprises sending to the first device for first presentation to the first user the combined image. Next, step 2216 comprises sending to the second device for second presentation to the second user the combined image.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2300 according to an embodiment are shown. As seen in this FIG. 2G, step 2302 comprises obtaining by a processing system including a processor, from a mobile communication device being utilized by a first user while the first user is in a first physical store, a first video steam depicting a first item currently available for purchase in the first physical store. Next, step 2304 comprises facilitating by the processing system a collaborative shopping session between the mobile communication device of the first user and a communication device of a second user. Next, step 2306 comprises obtaining by the processing system at least one shopping preference of the second user. Next, step 2308 comprises selecting by the processing system, based at least in part upon the at least one shopping preference of the second user, a selected other physical store, the selected other physical store being remote from the first physical store, the selected other physical store being selected from among at least a second physical store and a third physical store. Next, step 2310 comprises obtaining by the processing system from a camera located in the selected other physical store a second video stream depicting a second item that is currently available for purchase in the selected other physical store. Next, step 2312 comprises sending by the processing system to the mobile communication device the second video stream to facilitate a first display by the mobile communication device of an augmented reality presentation to the first user, the augmented reality presentation comprising both the first video stream and the second video stream. Next, step 2314 comprises generating by the processing system a combined video stream based at least in part upon the first video stream and the second video stream. Next, step 2316 comprises sending by the processing system to the communication device of the second user the combined video stream for display to the second user.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

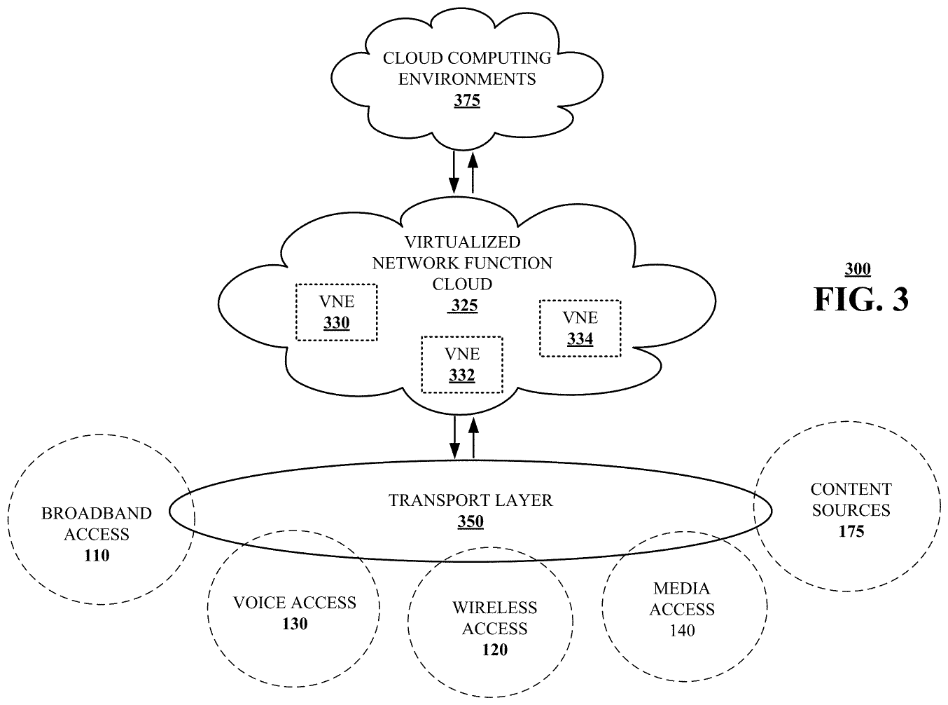

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the subsystems and functions of systems 200 and 250, and some or all of methods 2100, 2200 and 2300 presented in FIGS. 1, 2A-2B, 2E-2G. For example, virtualized communication network 300 can facilitate in whole or in part collaborative shopping (e.g., collaborative shopping between a first user in a first location and a second user in a second (different) location).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

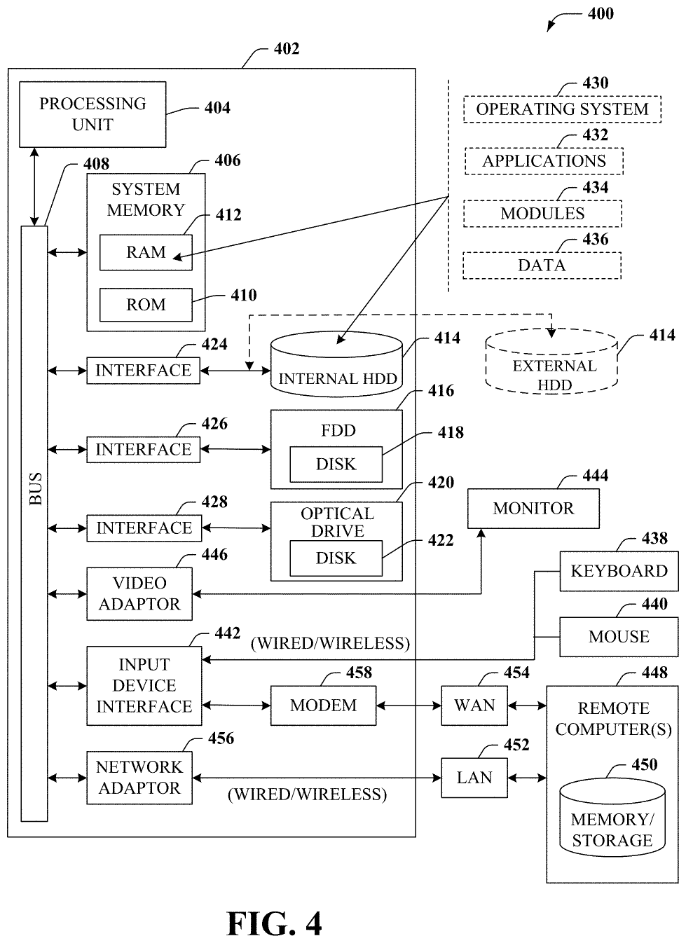

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part collaborative shopping (e.g., collaborative shopping between a first user in a first location and a second user in a second (different) location). Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

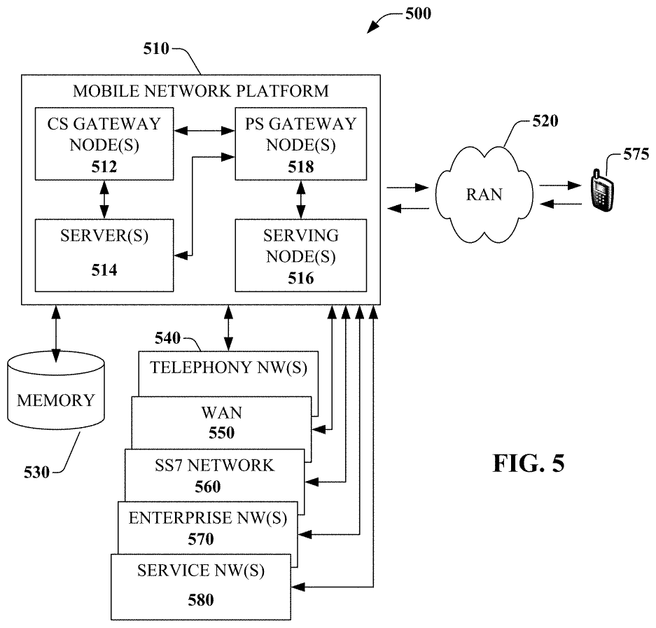

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part collaborative shopping (e.g., collaborative shopping between a first user in a first location and a second user in a second (different) location). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

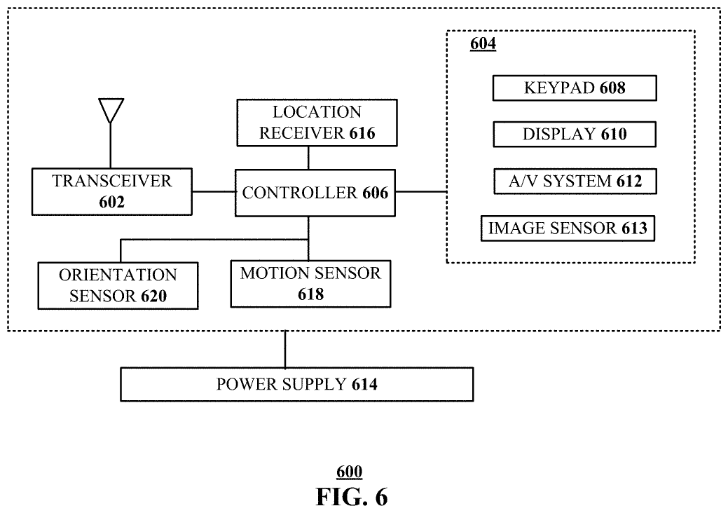

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part collaborative shopping (e.g., collaborative shopping between a first user in a first location and a second user in a second (different) location).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically facilitating collaborative shopping) can employ various AI-based schemes for carrying out various embodiments thereof. Moreover, the classifier can be employed to determine a ranking or priority related to such collaborative shopping. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which item(s) and/or store(s) to use for the collaborative shopping displays.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
facilitating a collaborative shopping session between first equipment of a first user and second equipment of a second user;
obtaining a first shopping preference of the first user;
obtaining a first image of first stock currently available for purchase in a first physical store;
selecting, based at least in part upon the first shopping preference of the first user, a selected other physical store, the selected other physical store being remote from the first physical store, the selected other physical store being selected from among at least a second physical store and a third physical store;
obtaining a second image of second stock currently available for purchase in the selected other physical store;
combining the first image and the second image into a combined image;
sending to the first equipment for first presentation to the first user the combined image; and
sending to the second equipment for second presentation to the second user the combined image.

2. The device of claim 1, wherein:
the first equipment comprises a first mobile communication device, a first smartphone, a first tablet computer, a first laptop computer, a first desktop computer, or any combination thereof; and
the second equipment comprises a second mobile communication device, a second smartphone, a second tablet computer, a second laptop computer, a second desktop computer, or any combination thereof.

3. The device of claim 1, wherein the collaborative shopping session is carried out via a first web browser operating on the first equipment of the first user and a second web browser operating on the second equipment of the second user.

4. The device of claim 1, wherein the first shopping preference of the first user comprises a rank-ordered list of preferred physical stores and wherein the selecting the selected other physical store is based upon the rank-ordered list.

5. The device of claim 1, wherein:
the first image is obtained in real-time from a first camera in the first physical store; and
the second image is obtained in real-time from a second camera in the second physical store.

6. The device of claim 1, wherein:
the first image depicts all or a portion of the first stock that is present on one or more first shelves of a first aisle of the first physical store; and
the second image depicts all or a portion of the second stock that is present on one or more second shelves of a second aisle of the second physical store.

7. The device of claim 1, wherein:
the first presentation is made on a first display screen of the first equipment of the first user, and the first presentation comprises a first augmented reality presentation, a first virtual reality presentation, or any combination thereof; and
the second presentation is made on a second display screen of the second equipment of the second user, and the second presentation comprises a second augmented reality presentation, a second virtual reality presentation, or any combination thereof.

8. The device of claim 1, wherein the combined image shows:
for the first stock, a first number of instances of a first type of item available for purchase; and
for the second stock, a second number of instances of a second type of item available for purchase.

9. The device of claim 8, wherein the first type of item and the second type of item are a same type of item.

10. The device of claim 1, wherein the operations further comprise obtaining a second shopping preference of the second user, wherein the selecting the selected other physical store is further based at least in part upon the second shopping preference of the second user.

11. The device of claim 1, wherein:
the operations further comprise performing image processing on the first image;
the first stock is depicted in the first image as a first type of item;
the image processing results in an identification of the first type of item; and
the selecting the selected other physical store is further based at least in part upon the identification of the first type of item.

12. The device of claim 11, wherein:
the selecting the selected other physical store based at least in part upon the identification of the first type of item further comprises selecting as the selected other physical store which one of the second physical store and the third physical store has more of the first type of item available for purchase.

13. The device of claim 1, wherein the facilitating the collaborative shopping session comprises facilitating communication between the first equipment of the first user and the second equipment of the second user, wherein the communication comprises visual communication, audio communication, or any combination thereof, and wherein the first user and the second user are part of a same social organization electronically created as followers.

14. The device of claim 13, wherein the facilitating the communication between the first equipment of the first user and the second equipment of the second user further comprises facilitating receipt of input from a third party, wherein the receipt of input from the third party comprises visual communication from the third party, audio communication from the third party, or any combination thereof, and wherein the third party is a subject matter expert.

15. A non-transitory machine-readable medium comprising executable instructions that, when executed by a processing system including a processor, facilitate performance of operations, the operations comprising:
facilitating a collaborative shopping session between a first device of a first user and second device of a second user;
obtaining at least one shopping preference of the first user;
obtaining a first image of first items currently available for purchase in a physical store;
selecting, based at least in part upon the at least one shopping preference of the first user, a suggested replacement item, the suggested replacement item being located in another physical store that is remote from the physical store, the suggested replacement item being selected from among at least a first potential replacement item and a second potential replacement item;
obtaining a second image of the suggested replacement item that is currently available for purchase in the another physical store;
generating a combined image based at least in part upon the first image and the second image;
sending to the first device for first presentation to the first user the combined image; and
sending to the second device for second presentation to the second user the combined image.

16. The non-transitory machine-readable medium of claim 15, wherein the at least one shopping preference of the first user is obtained from a database.

17. The non-transitory machine-readable medium of claim 16, wherein:
the first image comprises a first plurality of images in a first form of a first video stream obtained from a first video camera that is located in the first physical store; and
the second image comprises a second plurality of images in a second form of a second video stream obtained from a second video camera that is located in the second physical store.

18. A method comprising:
obtaining by a processing system including a processor, from a mobile communication device being utilized by a first user while the first user is in a first physical store, a first video steam depicting a first item currently available for purchase in the first physical store;
facilitating by the processing system a collaborative shopping session between the mobile communication device of the first user and a communication device of a second user;
obtaining by the processing system at least one shopping preference of the second user;
selecting by the processing system, based at least in part upon the at least one shopping preference of the second user, a selected other physical store, the selected other physical store being remote from the first physical store, the selected other physical store being selected from among at least a second physical store and a third physical store;
obtaining by the processing system from a camera located in the selected other physical store a second video stream depicting a second item that is currently available for purchase in the selected other physical store;
sending by the processing system to the mobile communication device the second video stream to facilitate a first display by the mobile communication device of an augmented reality presentation to the first user, the augmented reality presentation comprising both the first video stream and the second video stream;
generating by the processing system a combined video stream based at least in part upon the first video stream and the second video stream; and
sending by the processing system to the communication device of the second user the combined video stream for display to the second user.

19. The method of claim 18, wherein:
the augmented reality presentation comprises the second video stream displayed in a picture-in-picture manner within the first video stream; and
the combined video stream comprises the second video stream displayed in a picture-in-picture manner within the first video stream.

20. The method of claim 19, wherein:
the first video stream is obtained from a camera that is part of the mobile communication device; and
the second video stream obtained from a second video camera that is located in the second physical store.
